(19) United States
(12) Patent Application Publication
(10) Pub. No.: US 2009/0305861 A1
(43) Pub. Date: Dec. 10, 2009

(54) METHOD FOR MAKING DISTORTED FRAGMENTS

(76) Inventor: Donald E. Weder, Highland, IL (US)

Correspondence Address: DUNLAP CODDING, P.C., PO BOX 16370, OKLAHOMA CITY, OK, 73113, US

(21) Appl. No.: 12/264,599

(22) Filed: Nov. 4, 2008

Related U.S. Application Data
(63) Continuation-in-part of application No. 10/954,724, filed on Sep. 30, 2004, now abandoned.
Application No. 10/954,724 is a continuation-in-part of application No. 10/678,294, filed on Oct. 3, 2003, now abandoned.
Application No. 10/678,294 is a continuation of application No. 10/303,595, filed on Nov. 22, 2002, now Pat. No. 6,669,620.
Application No. 10/303,595 is a continuation of application No. 09/982,407, filed on Oct. 18, 2001, now abandoned.
Application No. 09/982,407 is a continuation of application No. 09/591,920, filed on Jun. 12, 2000, now abandoned.
Application No. 09/591,920 is a continuation of application No. 08/879,242, filed on Jun. 19, 1997, now abandoned.
Application No. 10/954,724 is a continuation-in-part of application No. 10/263,059, filed on Oct. 1, 2002, now abandoned.
Application No. 10/263,059 is a continuation of application No. 09/799,980, filed on Mar. 6, 2001, now abandoned.

(51) Int. Cl. B31B 1/36

(52) U.S. Cl. 493/459

(57) ABSTRACT

Distorted fragments having a variety of configurations and methods for making such distorted fragments is provided which, because of its increased bulk, can also be used as packing materials, decorative grasses, an animal bedding, cat litter, mulch for soil and a media for plants. The distorted fragments can be produced by extrusion and the extrudate is distorted while in a semi-solid state.

### CROSS REFERENCE TO RELATED APPLICATIONS

This application is a continuation-in-part of U.S. Ser. No. 10/954,724, filed Sep. 30, 2004, now abandoned; which is a continuation-in-part of U.S. Ser. No. 10/678,294, filed Oct. 3, 2003, now abandoned; which is a continuation of U.S. Ser. No. 10/303,595, filed Nov. 22, 2002, now U.S. Pat. No. 6,669,620; which is a continuation of U.S. Ser. No. 09/982,407, filed Oct. 18, 2001, now abandoned; which is a continuation of U.S. Ser. No. 09/591,920, now abandoned; which is a continuation of U.S. Ser. No. 08/879,242, filed Jun. 19, 1997, now abandoned. The U.S. Ser. No. 10/954,724 application is also a continuation-in-part of U.S. Ser. No. 10/263,059, filed Oct. 1, 2002, now abandoned; which is a continuation of U.S. Ser. No. 09/799,980, filed Mar. 6, 2001, now abandoned. The contents of each of the above identified applications and patents are hereby expressly incorporated herein by reference in their entirety.

### STATEMENT REGARDING FEDERALLY SPONSORED RESEARCH

Not applicable.

### BACKGROUND OF THE INVENTION

1. Field of the Invention

The present invention relates to distorted fragments useful as decorative grasses or packaging materials and methods for producing same.

2. Description of Related Art

Decorative grasses have been used for many years in Easter baskets, for other decorative purposes, or for packaging purpose. The decorative grasses of the prior art have been produced by numerous methods and from a variety of materials such as polymeric materials, paper or the like. Typically, such materials are cut and shredded to produce segments having predetermined dimensions. One such prior art method for making decorative grasses is disclosed in U.S. Pat. No. 4,292,266, issued to Weder et al., Application/8404.259-1-wherein a plastic film is extruded and cut into plastic strips which are passed through a slow-speed godet, an oven and a high-speed godet so that the strips are drawn down in width and thickness without breaking. From the high-speed godet, the strips or strands are chopped to a desired length and conveyed to a storage area for subsequent bagging and packaging.

While the prior art methods for making decorative grasses have been widely accepted, new and improved methods for making decorative grasses having improved aesthetic qualities are being sought which are less costly and wherein the decorative grasses have an improved feel. It is to such decorative grasses and methods for producing same that the present invention is directed.

### BRIEF DESCRIPTION OF THE DRAWINGS

FIG. 1 is a schematic representation of an extruder used to make distorted fragments in accordance with the present invention.

FIG. 2A is a frontal view of a die having an opening for producing an extrudate having a distorted cross-section profile.

FIG. 2B is an isometric view of the distorted extrudate produced by the die of FIG. 2A.

FIG. 3A is a side elevational view of a die having a tension spring like hollow cavity.

FIG. 3B is a side elevational view of a distorted extrudate produced by the die of FIG. 3A.

FIG. 4 is a side elevational view of a die and a cutting unit used for making distorted fragments in accordance with the present invention.

FIG. 5A is a top plan view of a die, a slitting unit, and a cutting unit for making distorted fragments in accordance with one embodiment of the present invention.

FIG. 5B is a top plan view of a die, a slitting unit, and a cutting unit for making distorted fragments in accordance with another embodiment of the present invention.

FIG. 5C is a frontal view of the die of FIGS. 5A and 5B, having an opening for producing an extrudate having a distorted cross-section profile in accordance with the present invention.

FIGS. 6A-6C are pictorial representations of three examples of distorted extrudates produced in accordance with the present invention.

FIG. 7A is a schematic representation of another embodiment for making distorted fragments in accordance with the present invention.

FIGS. 7B-7H are pictorial representations of examples of distorting units used in the production of distorted fragments in accordance with the method of FIG. 7A.

FIG. 8A is a schematic representation of another embodiment for making distorted fragments in accordance with the present invention.

FIG. 8B is a top plan view of a mold used in the production of distorted fragments in accordance with the method of FIG. 8A.

FIG. 9 is a schematic representation of another embodiment for making distorted fragments in accordance with the present invention.

FIGS. 10A-10D are schematic representations of distorted fragments with printed patterns and embossed patterns.

### DETAILED DESCRIPTION OF THE INVENTION

The present invention relates to distorted fragments having a variety of configurations and to methods for making such distorted fragments. The term “distorted fragments” as used herein, is defined as packaging materials having a distorted configuration (i.e., not in a configuration of a straight line), and decorative grasses having a distorted configuration (i.e., not in a configuration of a straight line). Non-limiting exemplary distorted configurations are wave, cork screw, tension spring, watch spring, pasta, curls, crimps, corrugations, zigzag, spiral, helix, and the like, and variations thereof. Because of the increased bulk of the distorted fragments of the present invention, such distorted fragments can be used as packing materials, decorative grasses, an animal bedding, cat litter, mulch for soil, a media for plants, and the like.

According to the present invention, a method for making distorted fragments includes providing an extruder. A raw material is fed into the extruder to produce an extrudate. The distortions are imparted to the extrudate when the extrudate is in a semi-solid state. The extrudate assumes a semi-solid state during the process of extrusion, during the process of solidification after extrusion, or during the process of re-liquifying after solidification. The extrudate with distortions imparted thereto can be individual distorted fragments or can produce distorted fragments after further processing.

“Semi-solid state” as the term is used herein, is defined as a physical state of matter similar to a solid in some respects, such as the ability to maintain a prescribed configuration, while sharing some properties of a liquid, such as the ability to flow under pressure.

In describing of the drawings, identical elements are assigned like numbers, while non-identical elements with similar functions are assigned like numbers followed by letters.

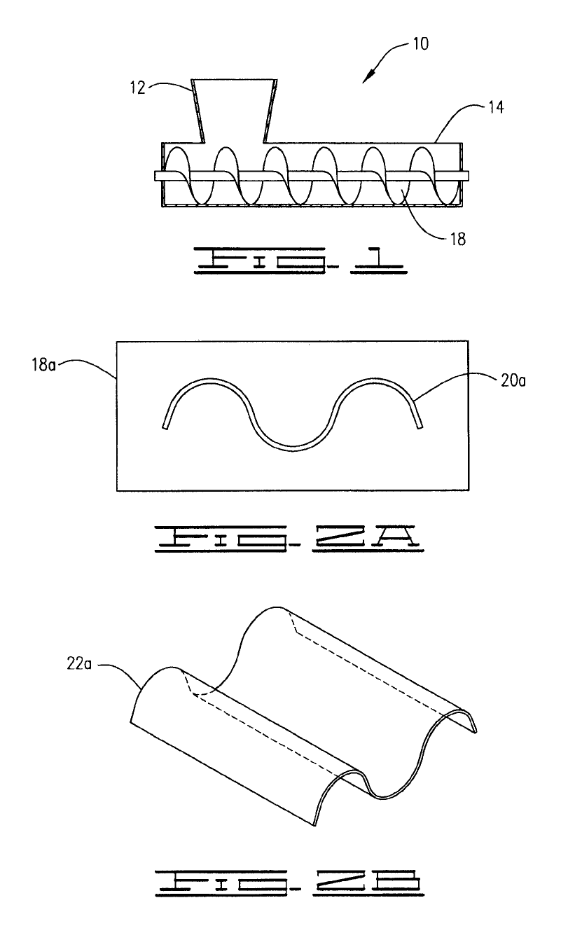

FIG. 1 illustrates schematically an extruder 10 employed to make distorted fragments in accordance with the present invention. Any known extruder capable of producing an extrudate can be employed. Examples of such known extruder are single screw extruders, twin or multiple screw extruders, and ram extruders and variations thereof. By way of example, the extruder 10 in FIG. 1 is a single screw extruder. A raw material capable of being extruded is fed from a hopper 12 into a barrel 14 of the extruder 10. The raw material comes into contact with a rotating screw 16 in the barrel 14. The screw 16 forces the raw material to move forward in the barrel 14, wherein the raw material assumes a semi-solid state. At the front of the barrel 14, the molten raw material is discharged from the barrel 14 and introduced into a die (described in detail herein after) or a mold (also described in detail herein after).

As shown in FIG. 2A, a die 18a operably connected to the extruder 10 has an opening 20a which has a cross-section profile of a desired distorted configuration. By way of example, a distorted extrudate 22a produced by the die 18a in FIG. 2A exhibits a configuration of a waved sheet as shown in FIG. 2B; however, it is to be understood that various configurations with distortions imparted thereto can be produced. Exemplary distorted configurations include, but are not limited to, watch spring, spiral, wave, zigzag, crimps, corrugations, and the like.

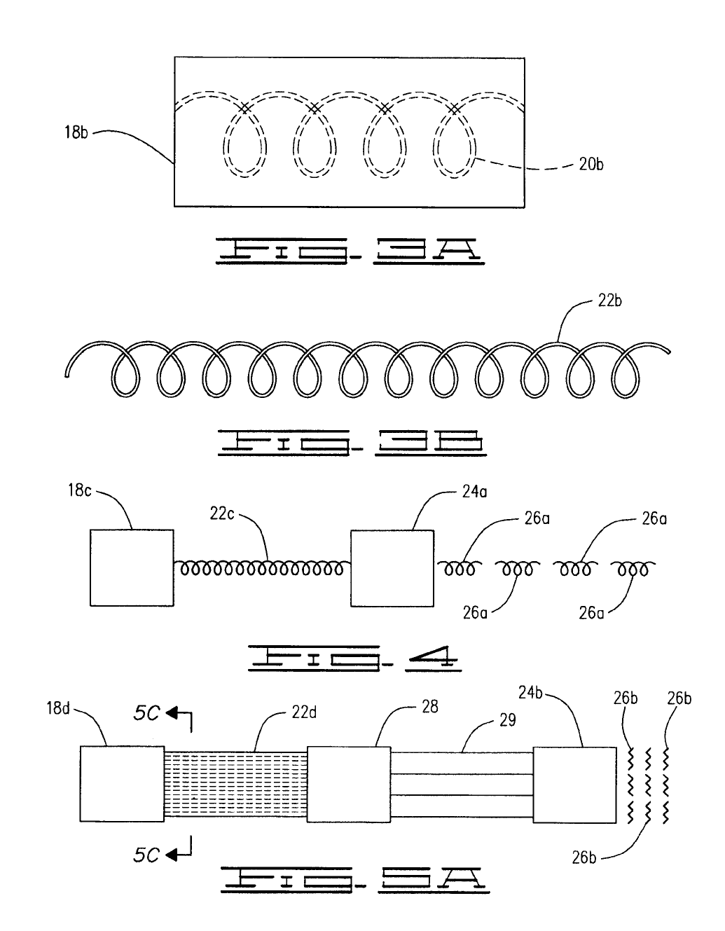

As shown in FIG. 3A, a hollow cavity 20b inside a die 18b resembles a desired distorted configuration to be imparted to an extrudate. By way of example, a distorted extrudate 22b produced by the die 18b immediately exhibits a configuration of a tension spring after extrusion as shown in FIG. 3B; however, it is to be understood that various configurations with distortions imparted thereto can be produced. Exemplary distorted configurations include, but are not limited to, wave, cork screw, tension spring, helix, and the like.

Any raw material capable of been extruded can be used to make distorted fragments according to the present invention utilizing the extruder 10 in combination with the die 18a or 18b described in FIGS. 2A and 3A. Suitable raw material includes, but not limited to, thermoplastic (thermoformable plastic), thermosetting plastic, metal, wood pulp, recycled paper pulp, food, and combination thereof. When plastic or metal is used as the raw material, it may be desirable to pass the distorted extrudate through a cooling unit to allow the distorted extrudate to solidify so as to maintain the distorted configuration in the extrudate. Those skilled in art will realize that different methods may be used in the cooling unit, such as cooled in the air or cooled in a water bath, and the like. However, it is understood that the cooling unit does not need to be a separate unit. For example, the distorted extrudate can be cooled to solidify inside the die's passage (i.e., using air or water to cool down). When wood pulp or recycled paper pulp is used as the raw material, it may be desirable to pass the distorted extrudate through a drying unit to eliminate extra liquid so as to allow the distorted extrudate to dry and solidify.

The extruder 10 may be operated to extrude continuously or semi-continuously. When the extruder 10 is operated to extrude continuously, the extruder 10 produces a distorted extrudate 22c of a theoretically indefinite length. The distorted extrudate 22c is then fed into a cutting unit 24a to produce distorted fragments 26a as shown in FIG. 4. Any known method and device can be employed as the cutting unit 24a to cut the distorted extrudate. Examples of such known method and device are rotary knives, reciprocating knives, die cutting, laser cutting, water jet cutting, air jet cutting and the like. However, it is understand that the cutting unit 24a does not need to be a separate unit. For example, the die 18c can incorporate a cutter so that the distorted extrudate is immediately cut into distorted fragments when it is extruded out of the die 18c. By way of example, the distorted fragments 26a described in FIG. 4 exhibits a configuration of tension spring; however, it is to be understood that various configurations with distortions imparted thereto can be produced.

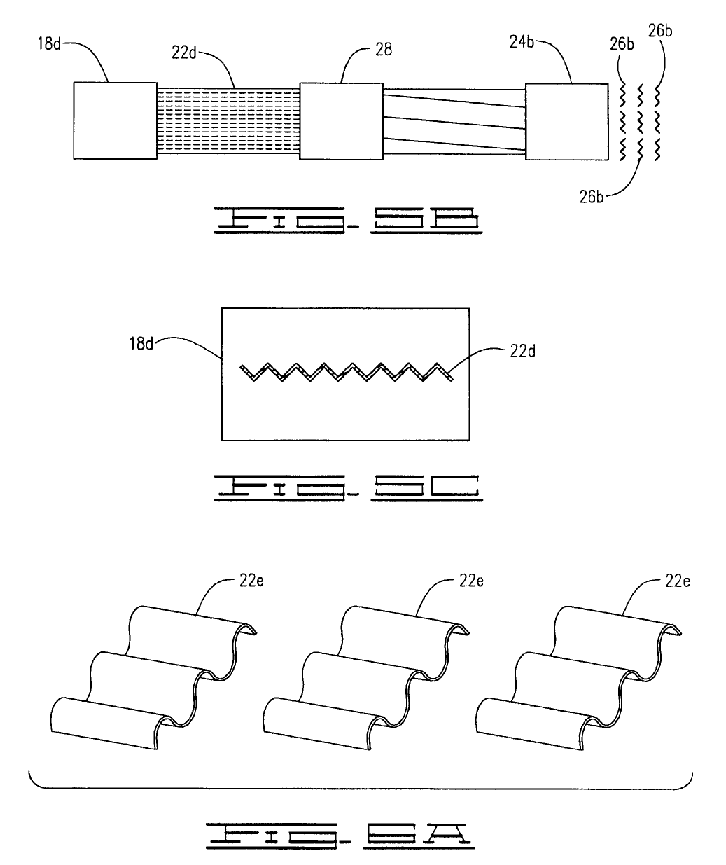

Alternatively, as shown in FIGS. 5A and 5B, the distorted extrudate 22d, produced from a die 18d, passes through at a slitting unit 28 and a cutting unit 24b to produce distorted fragments 26b. The slitting unit 28 produces a slit extrudate 29 having a plurality of strips of predetermined width. Any known method and device can be employed in the slitting unit 28. Such common methods of slitting the distorted extrudate 22d include: (a) slitting the distorted extrudate 22d so that the longer dimension of the strips is in the direction of travel of the distorted extrudate 22d (i.e., the machine direction); or (b) slitting the distorted extrudate 22d so that the longer dimension of the strips is oblique to the direction of travel of the distorted extrudate 22d, (i.e., obliquely to the machine direction). The slit extrudate 29 is then passed through the cutting unit 24b to form the distorted fragments 26b. By way of example, the distorted fragments 26b described in FIGS. 5A and 5B exhibit a configuration of crimps, produced from the die 18d as shown in FIG. 5C; however, it is to be understood that various configurations with distortions imparted thereto can be produced.

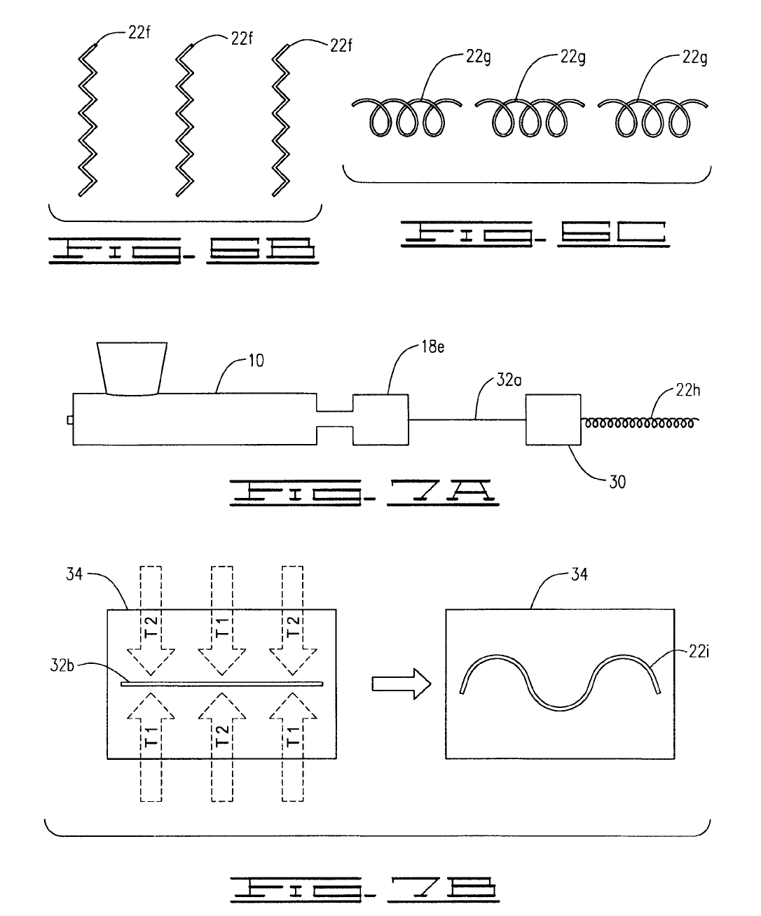

When the extruder 10 is operated to extrude semi-continuously, or in pulse, the extruder 10 produces segments of distorted extrudate of a predetermined length. The length of the segments of distorted extrudate may vary largely depending on the final product made from the segments of distorted extrudate. Examples of the segments of distorted extrudate are assigned the numbers 22e, 22f, and 22g in FIGS. 6A-6C respectively. When the segments of distorted extrudate are in a configuration of a sheet, for example, 22e in FIG. 6A, the segments of distorted extrudate 22e may be fed into a cutting unit and/or a slitting unit to produce distorted fragments as previously described above. When the segments of distorted extrudate are in a configuration of a fragment, for example, 22f and 22g in FIG. 6B-6C, the segments of distorted extrudate 22f may be fed into a slitting unit to produce distorted fragments or the segments of distorted extrudate 22g may be individual distorted fragments without any further processing steps.

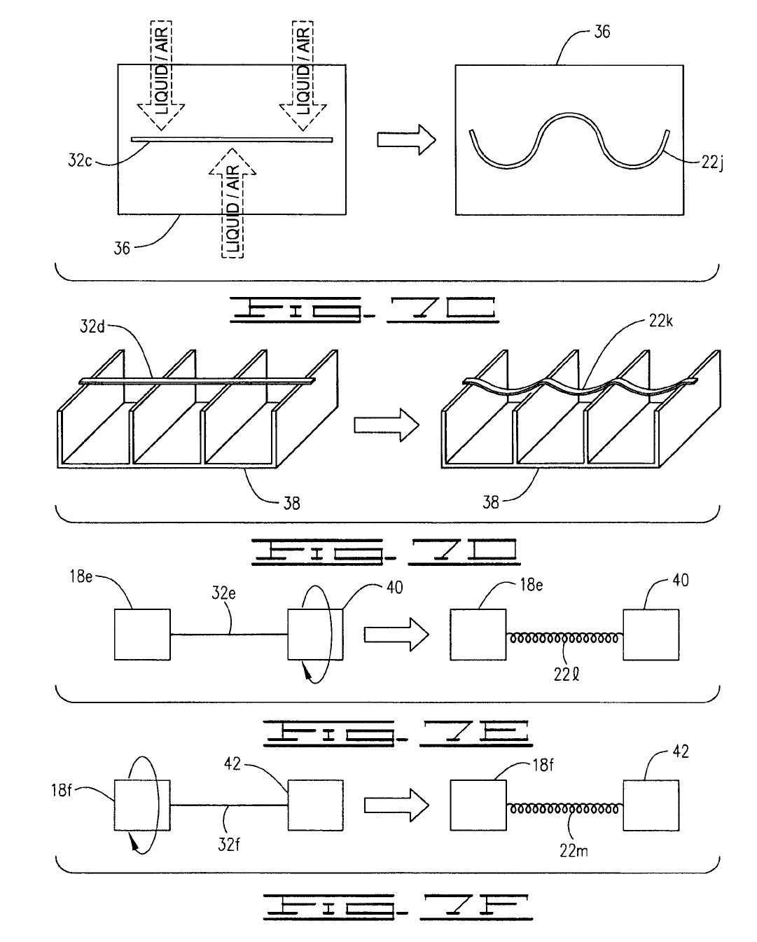

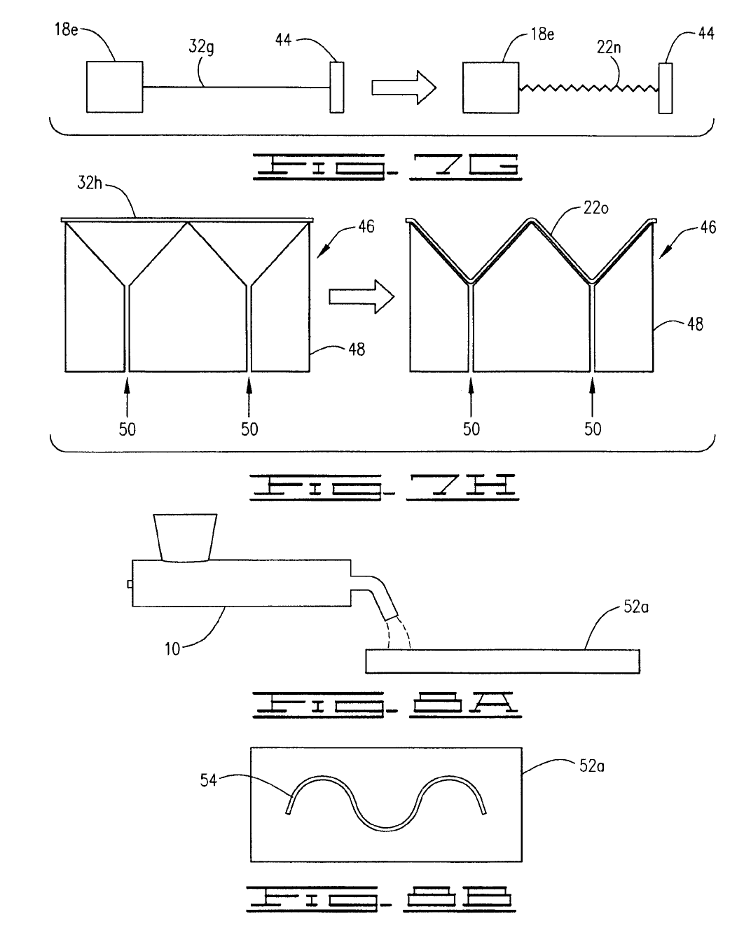

FIG. 7A illustrates schematically another embodiment for making distorted fragments in accordance with the present invention. The method includes providing the extruder 10, a die 18e and a distorting unit 30. Raw material capable of being extruded is fed into the extruder 10 and extruded from the die 18e to form an extrudate 32. The extrudate 32 passes through the distorting unit 30 to produce a distorted extrudate 22h during a semi-solid state.

As previously described, any raw material capable of be extruded can be used in the embodiment described in FIG. 7A. Suitable raw material includes, but not limited to, thermoplastic (thermoformable plastic), thermosetting plastic, metal, wood pulp, recycled paper pulp, food, and combination thereof.

Different embodiments of the distorting unit 30 are illustrated in FIGS. 7B-7H. By way of example, the extrudate 10 can be in a configuration of a strip in FIGS. 7B-7G or a configuration of a sheet in FIG. 7H; however, it is to be understood that any configuration can be utilized in the practice of the present invention.

As shown in FIG. 7B, the distorting unit 30 can be a cooling unit 34 which can control the temperature during cooling down. When temperature on one side of a semi-solid extrudate 32b is lower than the other side, it will result in a net shrinkage on the side with lower temperature to form a curl to produce a distorted extrudate 22i. The location, direction, and degree of the curl can be controlled by varying the temperature of cooling down. The cooling unit 34 can use either water or air to cool the semi-solid extrudate 32b.

As shown in FIG. 7C, the distorting unit 30 can also be a water bath 36 which exhibit alternative water flows of opposite directions while cooling down a semi-solid extrudate 32c. Water flow in one direction pushes the semi-solid extrudate 32c to bulge in that direction to form a curl to produce a distorted extrudate 22j. The location, direction, and degree of the curl can be controlled by varying the direction and speed of water flow in the water bath 36. Alternatively, the distorting unit 30 can also be an air bath which blows air alternatively in opposite directions while cooling down the semi-solid extrudate 32c. Air blown in one direction pushes the semi-solid extrudate 32c to bulge in that direction to form a curl. The location, direction, and degree of the curl can be controlled by varying the direction and speed of air flow in the air bath.

As shown in FIG. 7D, the distorting unit 30 can also be a baffle 38 on which a semi-solid extrudate 32d is deposed during cooling down. Gravity cause portions of the semi-solid extrudate 32d between the individual leaves of the baffle 38 to drop downwardly, thus creating distortions on the semi-solid extrudate 32d to produce a distorted extrudate 22k.

As shown in FIG. 7E, the distorting unit 30 can also be a turning device 40 that engages a semi-solid extrudate 32e and turns it clockwise or counter-clockwise to impart distortions on the semi-solid extrudate 32e to produce a distorted extrudate 22l while it is cooled down. Alternatively, a holding device 42 can hold the end of a semi-solid extrudate 32f at a fixed position while a turning die 18f turns clockwise or counter-clockwise to impart distortions on the semi-solid extrudate 32f to produce a distorted extrudate 22m as shown in FIG. 7F. Alternatively, both a turning die 18f and a turning device 40 can be employed at the same time to produce a distorted extrudate.

As shown in FIG. 7G, the distorting unit 30 can also a rigid surface 44 positioned a distance from the die. The semi-solid extrudate 32g impinges against the rigid surface 44 to form random distortions in the extrudate 32g to produce a distorted extrudate 22n.

When thermoplastic is used as the raw material, the distorting unit 30 can also be a thermoforming machine. A typical thermoforming machine heats the thermoplastic extrudate to its softening point and then configurations the semi-solid materials at a forming station utilizing various molds and/or vacuum or air pressure assists. Typical methods used by the thermoforming machine include, but not are limited to, vacuum forming, pressure forming, twin-sheet forming, drape forming, free blowing, and simple sheet bending. As understood by those skilled in the art, any suitable thermoforming method which can produce distorted materials can be used. For example, as shown in FIG. 7H, in a vacuum forming machine 46, a sheet of extrudate 32h is laid in a mold 48 of the desired distorted configuration. Appropriate suction perforations 50 are provided in the mold structure in order to draw the sheet of extrudate 32h downwardly into the mold 48 and thus configuration the extrudate 32h into the desired distorted configuration to produce the distorted extrudate 22o.

The extruder 10 may be operated to extrude continuously or semi-continuously. When the extruder 10 is operated to extrude continuously, the method produces a distorted extrudate of a theoretically indefinite length. When the distorted extrudate are in a configuration of a strip, for example, as shown in FIGS. 7B-7G, the distorted extrudate may be fed into a cutting unit to produce distorted fragments. When the distorted extrudate are in a configuration of a sheet, for example, as shown in FIG. 7H, the distorted extrudate may be fed into a cutting unit and/or a slitting unit to produce distorted fragments.

When the extruder 10 is operated to extrude semi-continuously, or in pulse, the extruder 10 produces many segments of distorted extrudate of a predetermined length. The length of the segments of distorted extrudate may vary largely depending on the final product made from the segments of distorted extrudate. When the distorted extrudate are in a configuration of a strip, for example, as shown in FIGS. 7B-7G, the distorted extrudate may be individual distorted fragments. When the distorted extrudate are in a configuration of a sheet, for example, as shown in FIG. 7H, the distorted extrudate may be fed into a slitting unit to produce distorted fragments.

As described above, any known method and device can be employed in the slitting unit and the cutting unit. Such method and device are well known to those skilled in the art and will not be described further in detail.

It should be noted that the arrangement of the distorting unit, the slitting unit and the cutting unit is not critical and may vary without departing from the inventive concept disclosed herein. For example, the extrudate can pass through the slitting unit first, then the distorting unit, and the distorted extrudate can pass through the cutting unit. That is, the distorted fragments can be produce when the distorting unit, the slitting unit and the cutting unit are arranged in any order.

FIG. 8A illustrates schematically another embodiment for making distorted fragments in accordance with the present invention. The method includes providing the extruder 10 and a mold 52a. The mold 52a contains a hollow cavity 54 resembling a distorted configuration. Raw material capable of be extruded is fed into the extruder 10 and extruded into the mold 52a. After the material in the mold 52a solidifies, a distorted product is ejected or broken out from the mold 52a. By way of example, the distorted product is a strip of a configuration of a wave as shown in FIG. 8B; however, it is to be understood that various configurations with distortions imparted thereto can be produced.

The distorted product may be individual distorted fragments (as shown in FIG. 8B) or a sheet of materials which, after passing through a slitting unit and/or a cutting unit, to produce distorted fragments. Any known method and device can be employed in the slitting unit and the cutting unit as described above.

As previously described, any raw material capable of be extruded can be used in the embodiment described in FIG. 8A. Suitable raw material includes, but not limited to thermoplastic, thermosetting plastic, metal, wood pulp, recycled paper pulp, food, and combination thereof.

When the raw material is a plastic, the mold 52a can be an injection mold 52b as shown in FIG. 9, and the materials can be injected under high pressure into the injection mold 52b. By way of example, the distorted product 56 is a strip of a configuration of a wave as shown in FIG. 9; however, it is to be understood that various configurations with distortions imparted thereto can be produced.

Referring to all above described embodiments, the distorted fragments may have a scent disposed thereof. The term “scent” as used herein refers to any odor or combination of odors normally associated with an object, such as a fruit, vegetable, or spice, and which are desired for a particular application. Examples of such scents include odors normally associated with flowers, plants, fruits, vegetables, foods, grasseses, food condiments (such as honey, sugar, salt), herbs, spices, woods, roots and the like. Such scents are known in the art and are commercially available. The scent may be incorporated into the raw material from which the distorted fragments is formed. Alternatively, the scent may be applied to the distorted fragments after it is formed by any known method or device.

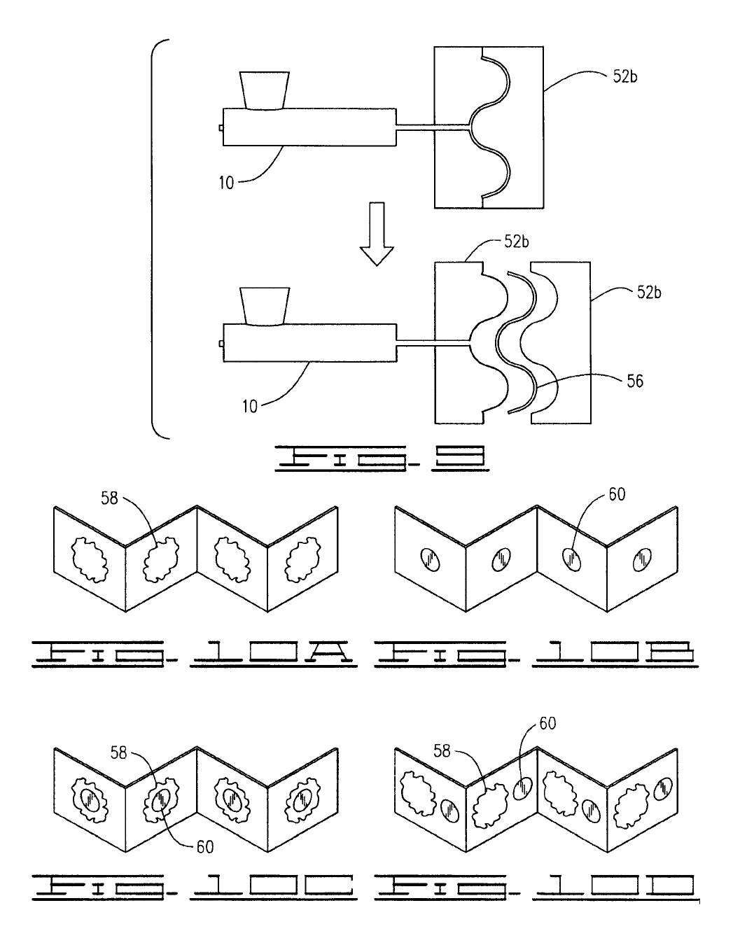

The distorted fragments may have a printed pattern 58 (as shown in FIG. 10A) and/or an embossed pattern 60 (as shown in FIG. 10B) on at least one surface thereof. The printed pattern 58 and the embossed pattern 60 may be applied to the distorted fragments by any known method or device.

The printed pattern 58 can be printed on the distorted fragments in a conventional manner so that, when the distorted fragments is produced, at least a substantial portion of the distorted fragments contains at least a portion of the printed pattern 58. Further, different colors can be employed in the printed pattern 58.

The embossed pattern 60 can be provided on the distorted fragments in a conventional manner so that, when the distorted fragments is produced, at least a substantial portion of the distorted fragments contains at least a portion of the embossed pattern 60.

Further, the distorted fragments can be provided with a printed pattern 58 as well as an embossed pattern 60 and the embossed pattern 60 can be either in register (as shown in FIG. 10C) or out of register (as shown in FIG. 10D) with the printed pattern 58. The printed pattern 58 and embossed pattern 60 can be provided on the distorted fragments so that when the distorted fragments is produced, at least a substantial portion of the distorted fragments contains at least a portion of the printed pattern 58 and at least a portion of the embossed pattern 60.

The distorted fragments produced can then be conveyed to a storage area which may be in the form of a suitable bin, or the distorted fragments may be conveyed to a packaging machine, or the distorted fragments may be conveyed to a baling machine for baling prior to storage. As other alternatives, the distorted fragments may be placed into boxes or cartons, subjected to further processing immediately or held for subsequent processing.

The description of the present invention is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

1. A method for producing distorted fragments comprising the steps of:
providing a raw material capable of being extruded;
extruding the raw material to produce a distorted extrudate having distortions imparted thereto; and
solidifying the extrudate to produce the distorted fragments.

2. The method of claim 1, wherein the distortions are imparted to the distorted extrudate during the extrusion process.

3. The method of claim 1, further comprising the step of passing the distorted extrudate through a cutting unit.

4. The method of claim 1, further comprising the step of passing the distorted extrudate through a cutting unit and a slitting unit.

5. The method of claim 1, wherein the raw material is selected from the group consisting of thermoplastic, thermosetting plastic, metal, wood pulp, recycled paper pulp, food, and combination thereof.

6. The method of claim 1, wherein the step of extruding the raw material is operated continuously.

7. The method of claim 1, wherein the step of extruding the raw material is operated semi-continuously.

8. A method for producing distorted decorative grasses comprising the steps of:
providing a raw material capable of being extruded;
extruding the raw material to produce a distorted extrudate having distortions imparted thereto; and
solidifying the extrudate to produce the distorted decorative grasses.

9. The method of claim 8, wherein the distortions are imparted to the distorted extrudate during the extrusion process.

10. The method of claim 8, further comprising the step of passing the distorted extrudate through a cutting unit.

11. The method of claim 8, further comprising the step of passing the distorted extrudate through a cutting unit and a slitting unit.

12. The method of claim 8, wherein the raw material is selected from the group consisting of thermoplastic, thermosetting plastic, metal, wood pulp, recycled paper pulp, food, and combination thereof.

13. The method of claim 8, wherein the step of extruding the raw material is operated continuously.

14. The method of claim 8, wherein the step of extruding the raw material is operated semi-continuously.

15. A method for producing distorted packaging materials comprising the steps of:
providing a raw material capable of being extruded;
extruding the raw material to produce a distorted extrudate having distortions imparted thereto; and
solidifying the extrudate to produce the distorted packaging materials.

16. The method of claim 15, wherein the distortions are imparted to the distorted extrudate during the extrusion process.

17. The method of claim 15, further comprising the step of passing the distorted extrudate through a cutting unit.

18. The method of claim 15, further comprising the step of passing the distorted extrudate through a cutting unit and a slitting unit.

19. The method of claim 15, wherein the raw material is selected from the group consisting of thermoplastic, thermosetting plastic, metal, wood pulp, recycled paper pulp, food, and combination thereof.

20. The method of claim 15, wherein the step of extruding the raw material is operated continuously.

21. The method of claim 15, wherein the step of extruding the raw material is operated semi-continuously.

22-81. (canceled)
